(19) United States
(12) Patent Application Publication
(10) Pub. No.: US 2026/0220937 A1
(43) Pub. Date: Jul. 30, 2026

(54) Stackable Temporal Encoding in Multimodal Large Language Models for Video Understanding

(71) Applicant: Bytedance Technology Ltd., Grand Cayman (KY)

(72) Inventors: Zhe Liu, Sydney (AU); Yajing Kong, Sydney (AU); Jiyuan Zhang, Sydney (AU); Chao Bian, Sydney (AU); Zhenbang Sun, Sydney (AU); Guangrui Li, Sydney (AU)

(21) Appl. No.: 19/038,587

(22) Filed: Jan. 27, 2025

(51) Int. Cl. G06V 20/40; G06F 40/40; G06V 10/62; G06V 10/774

(52) U.S. Cl. CPC G06V 20/41; G06F 40/40; G06V 10/62; G06V 10/774

(57) ABSTRACT

Example methods and systems for video understanding using multimodal large language models are disclosed. One example method includes receiving multiple frames of a video. The multiple frames are encoded using a visual encoder to generate multiple first visual embeddings. The multiple first visual embeddings are encoded using a temporal encoder to generate multiple second visual embeddings that encode temporal information across two or more frames of the multiple frames of the video, where encoding the multiple first visual embeddings includes encoding the multiple first visual embeddings based on a convolutional unit that includes two or more of the multiple first visual embeddings. An input to a large language model (LLM) is generated based on the multiple second visual embeddings. An output of the LLM is generated using the input of the LLM by running the LLM, where the output of the LLM includes machine understanding of the video.

### TECHNICAL FIELD

The present disclosure relates to computer-implemented methods and systems for video understanding using large language models (LLMs).

### BACKGROUND

Large language models (LLMs) have advanced artificial intelligence (AI) with their ability to understand and follow human instructions, excelling in various tasks across domains. Building on these capabilities, multimodal large language models (MLLMs) extend LLMs to visual modalities, enabling LLMs to process and interpret images effectively. However, extending MLLMs from static images to videos is challenging due to the need for temporal understanding of a video. Techniques for effective video understanding are desirable.

### SUMMARY

The present disclosure involves methods and systems for video understanding using large language models (LLMs). One example method includes receiving multiple frames of a video. The multiple frames are encoded using a visual encoder to generate multiple first visual embeddings, where each of the multiple first visual embeddings corresponds to a respective frame of the multiple frames. The multiple first visual embeddings are encoded using a temporal encoder to generate multiple second visual embeddings that encode temporal information across two or more frames of the multiple frames of the video, where encoding the multiple first visual embeddings includes encoding the multiple first visual embeddings based on a convolutional unit, and the convolutional unit includes two or more of the multiple first visual embeddings. An input to a large language model (LLM) generated based on the multiple second visual embeddings for video understanding. An output of the LLM is generated using the input of the LLM by running the LLM, where the output of the LLM includes machine understanding of the video.

The previously described implementation is implementable using a computer-implemented method; a non-transitory, computer-readable medium storing computer-readable instructions to perform the computer-implemented method; and a computer system including one or more computer memories interoperably coupled with one or more hardware processors configured to perform the computer-implemented method or the instructions stored on the non-transitory, computer-readable medium. These and other embodiments may each optionally include one or more of the following features.

In some implementations, encoding the multiple first visual embeddings includes catenating the multiple first visual embeddings along a temporal dimension.

In some implementations, encoding the multiple first visual embeddings includes dividing the multiple first visual embeddings into multiple convolutional units, and applying a stackable temporal encoding operation on each of the multiple convolutional units.

In some implementations, the stackable temporal encoding operation includes convolving, using a convolutional kernel with a convolutional window size, the multiple first visual embeddings within the convolutional unit, and sliding the convolutional kernel within the convolutional unit with a stride along a temporal dimension.

In some implementations, the temporal encoder includes multiple layers, the encoding the multiple first visual embeddings based on the convolutional unit includes encoding the multiple first visual embeddings based on a first layer of the temporal encoder. The multiple second visual embeddings are encoded based on a second layer of the temporal encoder to generate multiple third visual embeddings, and the generating, based on the multiple second visual embeddings, the input to the LLM includes generating, based on the multiple third visual embeddings, the input to the LLM.

In some implementations, the encoding the multiple second visual embeddings based on the second layer of the temporal encoder to generate the multiple third visual embeddings includes reshaping the multiple second visual embeddings into multiple second convolutional units, and applying a second stackable temporal encoding operation on each of the multiple second convolutional units.

In some implementations, a size of each of the multiple the second visual embeddings is the same as a size of each of the multiple the third visual embeddings.

In some implementations, a total frame count corresponding to the multiple first visual embeddings along a temporal dimension is not a multiple of a total frame count corresponding to the convolutional unit, and encoding the multiple first visual embeddings includes padding the multiple first visual embeddings with additional visual embeddings along the temporal dimension to generate multiple padded first visual embeddings, where a total frame count corresponding to the multiple padded first visual embeddings is a multiple of the total frame count corresponding to the convolutional unit.

In some implementations, each of the multiple second visual embeddings has the same size as each of the multiple first visual embeddings.

In some implementations, generating, based on the multiple second visual embeddings, the input to the LLM includes generating, using a vision-language projector and as the input to the LLM, an output of the vision-language projector using the multiple second visual embeddings as an input to the vision-language projector.

In some implementations, the LLM is a Multimodal Large Language Model (MLLM) trained for image-text understanding, the input of the LLM further includes one or more language instructions provided by a user, and generating the output of the LLM using the input of the LLM by running the LLM includes generating a language response to the one or more language instructions provided by the user that comprises the machine understanding of the video based on the one or more language instructions provided by the user.

In some implementations, before encoding, using the visual encoder, the plurality frames to generate the multiple first visual embeddings, the method further comprises training the temporal encoder while keeping parameters of the visual encoder and the LLM fixed.

In some implementations, after training the temporal encoder, the method further comprises training the visual encoder, the temporal encoder, and the LLM together.

In some implementations, encoding the multiple first visual embeddings comprises convolving a convolutional kernel with the multiple first visual embeddings, wherein a size of the convolutional kernel is larger than or equal to a sum of (1) a size of a first visual embedding of the multiple first visual embeddings and (2) a size of a second visual embedding of the multiple first visual embeddings.

The subject matter described in this specification can be implemented in particular embodiments so as to realize one or more of the following advantages. For example, the techniques described in this specification can enhance MLLMs' understanding of complex temporal and spatial relationships in video data, for example, by (1) enhancing MLLMs' abilities in temporal reasoning, temporal perception, spatial reasoning, and/or action recognition, (2) improving MLLMs' performance in stability prediction, recognition of actions, object attributes, task completion, state, and/or motion, (3) boosting MLLMs' capabilities in state change and action localization, (4) enhancing MLLMs' capabilities in temporal relationship and spatial relationship, (5) improving MLLMs' understanding of temporal sequences, for example, in predicting previous and next actions, and/or (6) enhancing MLLMs' proficiency in action count and order, with improvement in ego reasoning.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A illustrates examples of video temporal understanding using multimodal large language models (MLLMs), according to some implementations.

FIG. 1B illustrates example LLaVA-OV's performance on fourteen temporal-related tasks across six example benchmarks, according to some implementations.

FIG. 2A illustrates an example architecture of a multimodal large language models (MLLM) that integrates a stackable temporal encoder (STE) module with an implicit temporal modeling architecture, according to some implementations.

FIG. 2B illustrates an example of a schematic diagram of the STE module, according to some implementations.

FIG. 3 illustrates example model performance comparisons, according to some implementations.

FIG. 4 illustrates example results for different frame compressions, according to some implementations.

FIGS. 5A and 5B illustrate example results for different frame compressions using bar graphs, according to some implementations.

FIG. 6 illustrates example results of the performance of LLaVA-Video on temporal-related tasks equipped with (labeled as STE) or without explicit temporal encoding across benchmarks, according to some implementations.

FIGS. 7A-7F illustrate example task-level model performance, according to some implementations.

FIGS. 8A and 8B illustrate an example case study of ActNet-QA, according to some implementations.

FIG. 9 illustrates example results comparing temporal learning in the visual space and the semantic space during both the pretraining and SFT stages, according to some implementations.

FIG. 10 illustrates example learning space ablation as a plug-in module, according to some implementations.

FIG. 11 illustrates example dataset ablation of LLaVA-OV, according to some implementations.

FIG. 12 illustrates example results of using STE pre-trained on video data and evaluated under varying frame reduction, according to some implementations.

FIG. 13 illustrates single-image and multi-image ability after supervised fine-tuning (SFT), according to some implementations.

FIG. 14 illustrates an example process of video understanding using multimodal large language models, according to some implementations.

FIG. 15 illustrates a schematic diagram of an example computer system, according to some implementations.

Like reference numbers and designations in the various drawings indicate like elements.

### DETAILED DESCRIPTION

Methods for improving video understanding (also referred to as video temporal understanding) in MLLMs vary in how they model temporal information, leading to two design approaches. One approach (also referred to as implicit temporal modeling) relies only on the LLM decoder. For example, some MLLMs leave temporal understanding entirely to the LLM decoder. They depend on the LLM to implicitly infer temporal relationships from sequential visual features. LLaVA-OV and LLaVA-Video are examples of implicit temporal modeling. In some cases, implicit temporal modeling may limit temporal understanding. Another approach (also referred to as explicit temporal modeling) introduces temporal encoders to explicitly model temporal dependencies before passing extracted features to the LLM. The temporal encoders can employ temporal aggregation or compression techniques.

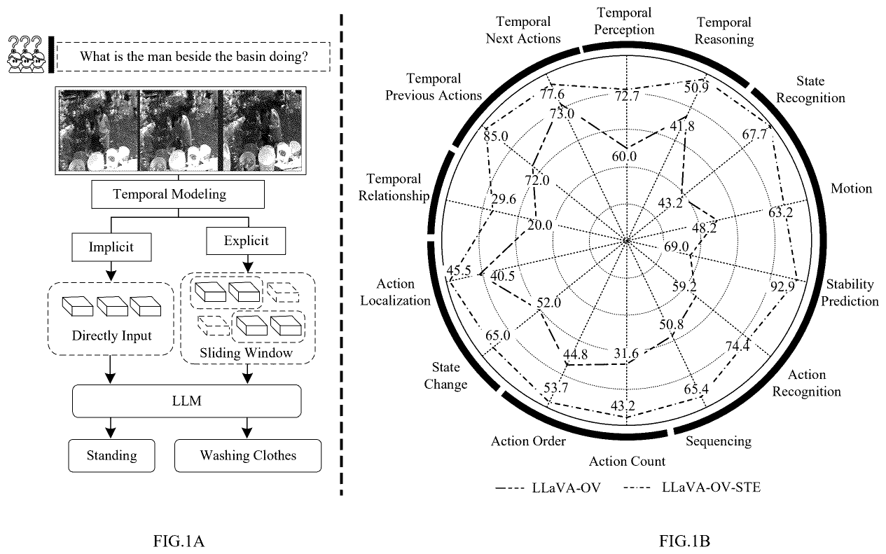

FIG. 1A illustrates examples of the two aforementioned approaches in video temporal understanding. The implicit temporal modeling relying solely on the LLM may process frames independently, therefore not capturing temporal dependencies. In contrast, the explicit temporal modeling, like sliding windows, encodes the temporal dependencies, improving temporal understanding but increasing structure complexity.

This disclosure provides techniques that relate to an explicit temporal modeling and introduce an example explicit temporal modeling model or module, referred to as a Stackable Temporal Encoder (STE), in MLLMs. The described techniques can improve video understanding by extracting and understanding dynamic relationships across frames to model time dependencies, which can be essential for tasks such as temporal reasoning of a video. In some implementations, the STE preserves temporal order through local convolution processing while allowing adjustable receptive fields to explore various temporal learning scales. Moreover, the flexible frame Input/Output (I/O) ratio of the STE can accommodate both variable frame compression ratios and uncompressed outputs. This adaptability can enable systematic studies of explicit temporal modeling and its broader impact. In some cases, the STE learns visual temporal information and offers adjustable temporal receptive fields and flexible token compression. In some implementations, by integrating the STE into two open-source models from the LLaVA series, LLaVA-OV and LLaVA-Video, the necessity, design and impact of explicit temporal modeling in video MLLMs can be systematically evaluated.

In some implementations, the performance of example MLLMs for video understanding, with and without the STE can be evaluated. In an experiment, across six example video MLLM benchmarks, it is found that incorporating the STE into LLaVA-OV and LLaVA-Video can improve their performance by 4.7% and 1.5%, respectively. Additionally, incorporating the STE for explicit temporal modeling can enable significant frame compression. Compressing frames by 87.5% with LLaVA-OV-STE can lead to a slight accuracy improvement of 0.8%, while a 75% frame compression with LLaVA-Video-STE can result in a modest accuracy drop of 0.5%, compared to their original versions with 32 frames. The results demonstrate the effectiveness of explicit temporal modeling incorporating the STE when compared to implicit temporal modeling.

FIG. 1B illustrates example LLaVA-OV's performance on fourteen temporal-related tasks across six example benchmarks. All tasks exhibit significant performance gains after incorporating the STE, showing that explicit temporal modeling incorporating the STE can improve temporal understanding.

In some implementations, two important aspects of explicit temporal modeling, i.e., temporal receptive fields and learning space, can be evaluated for model performance. In some cases, simply increasing the temporal receptive fields does not substantially improve model performance with a fixed frame number. However, increasing the temporal receptive fields can help mitigate information loss when compressing frames. In some cases, using STE to model temporal information explicitly is more effective in the visual space than in the semantic space. For example, applying convolutions before the vision-language projector can yield better performance while requiring significantly fewer parameters.

In some implementations, without supervised fine-tuning (SFT), STE can act as a lightweight plug-in module pre-trained on video datasets, achieving performance drops of less than 1.9% when reducing 75% frames for both LLaVA-OV and LLaVA-Video models. The results highlight the adaptability and potential of STE for fast deployment in practical scenarios. Additionally, the STE can have effects beyond video modalities. For example, while single-image performance experiences a slight decline, likely due to the absence of image datasets during fine-tuning, multi-image tasks benefit significantly from incorporating the STE in MLLMs.

In some implementations, the aforementioned results can provide insights for improving temporal understanding in future video MLLMs.

In some implementations, STE can be integrated into open-source LLaVA series to form an overall model. STE can be designed to capture visual temporal information, facilitating a systematic investigation into what information temporal encoding learns and how the learned information influences the overall model.

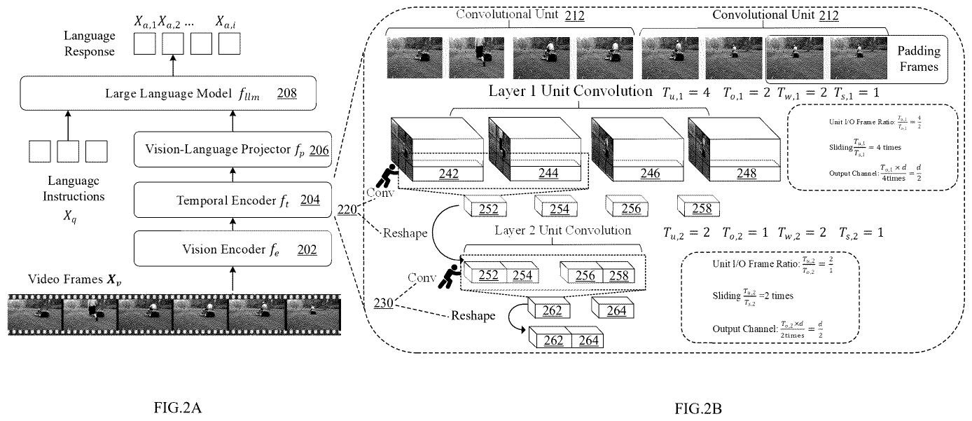

FIG. 2A illustrates an example architecture of an MLLM that integrates a temporal encoder 204 with an implicit temporal modeling architecture, for example, a LLaVA architecture. Given visual inputs Xᵥ and an instruction X_{q}, a vision encoder 202 can be employed to extract visual embeddings Zᵥ=fₑ(Xᵥ). The temporal encoder 204 that includes a STE is then applied to capture temporal information within the extracted visual embeddings, resulting in

$${Z}_{v}^{′} = {f}_{t} ( {Z}_{v} ) .$$

The vision-language projector 206 will further project visual embedding

$${Z}_{v}^{′}$$

into the semantic space, generating semantic tokens

$${H}_{v} = {f}_{p} ( {Z}_{v}^{′} ) .$$

These semantic tokens are combined with the instruction tokens and any previously generated tokens, and are fed into an LLM decoder 208 to predict the next output token xᵢ=fₗₗₘ(Hᵥ, X^{q}, X_{α,<i}), where X_{α,<i} denotes the answer tokens responding to the instruction generated before xᵢ. Then, the probability of the target answers X_{α} in a causal manner can be computed as:

$$p ( {X}_{a} \vert {X}_{v} , {X}_{q} ) = {\prod }_{i = 1}^{L} p ( {x}_{i} \vert {X}_{v} , {X}_{q} , {X}_{a , < i} ) \qquad ( 1 )$$

In some implementations, the output of an LLM, e.g., the language response from the LLM decoder 208, can be a language response that includes multiple textual tokens, e.g., the aforementioned output tokens xᵢ, that reflect the machine understanding of the video by utilizing the video understanding techniques described here.

In some implementations, the temporal encoder 204 can be used before the vision encoder 202, between the vision encoder 202 and the vision-language projector 206, after the vision-language projector 206, or a combination thereof.

In some implementations, the STE can encode temporal information through convolutions across frames and enables flexible compression ratios by adjusting the number of output convolution channels. Each output channel of convolutional layers in the STE represents a distinct view of the input frames within the sliding windows. By varying the output channel count, the convolutional layers learn multiple views of temporally continuous information, encoding temporal dependencies and generating embeddings with the desired output shape. The STE can support an arbitrary input/output (I/O) frame ratio of ( [symbol] ₊: [symbol] ₊), enabling STE to transform any number of input frames into any number of output frames, thereby facilitating diverse encoding and compression explorations.

FIG. 2B illustrates an example of a schematic diagram of the STE model. In some implementations, given a sequence of visual embeddings Zₜ for t∈[1, T], where Zₜ ∈ [symbol] ^{1×p×d} represents the embedding of a frame, with T as the number of frames and p as the number of patches per frame, STE first concatenates the embeddings along the temporal dimension to enable temporal convolution:

$${Z}_{v} = [ {Z}_{1} , {Z}_{2} , … , {Z}_{T} ] , {Z}_{v} ∈ {ℝ}^{1 \times p \times ( dT )} \qquad ( 2 )$$

In some implementations, since the input frame length is dynamic, the output channel count may not be calculated directly to implement the arbitrary I/O frame ratio of (N₊:N₊). Therefore, the dynamic video can be divided or split into multiple convolutional units (e.g., convolutional units 212). In each unit, the same or similar operations can be performed to ensure the same I/O ratio within the unit and, thus, for the whole dynamic video.

In some implementations, (T_{u,l}:T_{o,l}) can be defined as the frame I/O ratio for the convolutional unit in the l-th layer of STE, where T_{u,l} ∈ [symbol] ₊ denotes the input frame count for each convolutional unit, and T_{o,l} ∈ [symbol] ₊ represents the target output frame count after compression. The dynamic-length video can then be padded as:

$${Z}_{v} = [ {Z}_{1} , {Z}_{2} , … , {Z}_{T} , {\underbrace{{Z}_{T} , {Z}_{T} , … , {Z}_{T}}}_{k times} ] , \qquad ( 3 )$$

where k=T_{u,l}−(T mod T_{u,l}). In some cases, the video is padded for two reasons: (1) enabling the video length to be split into multiple convolutional units, and (2) ensuring that the video can be compressed at a ratio of (T_{u,l}:T_{o,l}). For example, a video with 31 frames cannot be directly processed with a ratio of (2:1) along the temporal dimension unless 1 frame is padded.

In some implementations, the number of frames included in a convolution window and a stride can be annotated as T_{w,l} and T_{s,l}. In some implementations, to run the sliding mechanism, two conditions, (1) T_{w,l}≤T_{u,l}, and (2) T_{u,l} mod T_{s,l}=0, are considered in selecting appropriate T_{w,l} and T_{s,l}, which can ensure consistent operations for each convolutional unit across the entire video. Then, the output channel count Cₗ can be calculated as

$${C}_{l} = \frac{{T}_{o , l} \times d}{N} ,$$

where

$$N = \frac{{T}_{u , l}}{{T}_{s , l}}$$

denotes the number of sliding operations in each convolutional unit. Circular padding is applied to ensure that exactly N sliding operations can be performed for any T_{w,l}.

Using the designed output channel count Cₗ, the desired frame I/O ratio (T_{u,l}, T_{o,l}) for the l-th convolutional layer can be achieved by concatenating the outputs of different channels along the temporal dimension, i.e., in the sliding order. The total output shape of the entire video is:

$${Z}_{v , l}^{′} ∈ {ℝ}^{1 \times p \times ( \frac{T + k}{T} \times N \times {C}_{l} )} = {ℝ}^{1 \times p \times \frac{( T \times k ) {T}_{o , l} d}{{T}_{u , l}}} \qquad ( 4 )$$

where

$${Z}_{v , l}^{′}$$

denotes the output of the l-th STE layer.

The visual embedding for each patch can then be split into

$$\frac{( T + k ) {T}_{o , l}}{{T}_{u , l}}$$

pieces of d-dimensional embeddings, each representing an abstract encoded frame. The splitting operation ensures size compatibility when stacking STE layers. Thus, the final output

$${Z}_{v}^{′}$$

for the vision-language projector is expressed as:

$${Z}_{v}^{′} = {( \underbrace{{f}_{f , L} ( {f}_{t , L - 1} ( … ( {f}_{t , 1}}}_{L layers} ( {Z}_{v} ) ) ) ) , \qquad ( 5 )$$

where L is the number of stacked layers in the STE fₜ.

As an example, the STE 204 illustrated in FIG. 2B includes 2-layer STE operations 220 and 230 that encode every four frames, for example, the four frames corresponding to visual embeddings 242, 244, 246, and 248 (e.g., first visual embeddings), into one abstract frame, for example, the frame corresponding to visual embedding 262, through stacking two layers of 50% frame compression. The visual embeddings 242, 244, 246, and 248 corresponding to the four frames is an example of a convolutional unit 212. The video, with dynamic length, is divided into multiple convolutional units 212, and the STE is designed to handle diverse Input/Output (I/O) frame ratios based on these units. T_{u,l}, T_{o,l}, T_{w,l}, and T_{s,l} denote the input frame count, the target output frame count, the convolutional window size, and the convolutional stride for a convolutional unit in the l-th layer, respectively. In some cases, visual embeddings 242, 244, 246, and 248 can have the same size.

In some implementations, during the first layer STE operation 220, two visual embeddings, e.g., 242 and 244 that corresponding to two consecutive frames, are convolved with a convolutional kernel to generate visual embedding 252. The convolutional kernel can have a size larger than or equal to the combined size of visual embeddings 242 and 244, therefore capturing, through the convolution operation, temporal information between the two frames corresponding to visual embeddings 242 and 244. For example, if visual embeddings 242 and 244 are one-dimensional vectors, the length of the convolutional kernel can be at least the combined length of visual embeddings 242 and 244. Similarly, visual embedding 254 can be generated by convolving the convolutional kernel with the two visual embeddings 246 and 248. Visual embeddings 256 and 258 can also be generated in a similar manner during the first layer STE operation, using visual embeddings in the next convolutional unit.

In some implementation, after visual embeddings 252, 254, 256, and 258 are generated through the aforementioned convolution operations in the first layer STE operation 220, they can be reshaped into new visual embeddings (e.g., second visual embeddings). In some implementations, each of the new visual embeddings can have the same size as that of visual embedding 242, and a similar STE operation can be applied on a second layer of the temporal encoder 204 to the reshaped visual embeddings. For example, visual embeddings 252 and 254 can be reshaped or combined into a new visual embedding that have the same size as that of visual embedding 242. The combined visual embeddings 252 and 254 can be used as an input visual embedding to the second layer STE operation, where the combined visual embedding of visual embeddings 252 and 254, as well as combined visual embedding of visual embeddings 256 and 258, can be convolved with the convolutional kernel used during the first layer STE operation, to generate a visual embedding 262. Visual embedding 264 can be generated in a manner similar to that for generating visual embedding 262. Then visual embeddings 262 and 264 can be reshaped or combined into a new visual embedding, i.e., a combined visual embedding of visual embeddings 262 and 264 (e.g., a third visual embedding). The size of the combined visual embedding of visual embeddings 262 and 264 can be the same as that of 242 in this example.

In some implementations, the first, second, or third visual embeddings can be used as input to vision-language projector 206. Therefore the STE operation in 220 or 230 can be applied in a multi-layer manner, without changing the convolutional kernel and/or the size of the output visual embeddings from the temporal encoder 204.

In some implementations, each of the STE operations 220 and 230 can be characterized by parameters such as an input frame count (e.g., T_{u,l}), a target output frame count (e.g., T_{o,l}), a convolutional window size (e.g., T_{w,l}), or a convolutional stride (e.g., T_{s,l}) for a convolutional unit. In some implementations, the aforementioned parameters can be the same or different for different STE operations in different layers. In some cases, the convolutional window size is the same as the size of the aforementioned convolutional kernel. The total frame count in a convolutional unit can be a multiple of the convolutional stride in the aforementioned convolution operation.

In some implementations, the input frame count and the target output frame count can reflect an I/O frame ratio (or frame compression ratio/rate), and the STE can be flexible to accommodate different compression ratio or no compression in each layer. In some implementations, the STE can be used as a stackable, reusable module in different layers with different parameters (e.g., the I/O frame ratios) to accommodate the dynamic size of the input video length and a desired size of the output of the temporal encoder 204 for inputting into the vision-language projector 206.

In some implementations, the training process of the overall model in FIG. 2A consists of two stages: pretraining and supervised fine-tuning (SFT). The training paradigm in both stages can be described as follows.

In some implementations, the pretraining stage can utilize a backbone's video understanding capabilities to initialize the STE, enabling it to effectively capture temporal information in videos. During pretraining, only the STE fₜ(·) is trained while the rest of the model (i.e., fₑ(·), fₚ(·), and fₗₗₘ(·)) is kept frozen. In this stage, a relatively high learning rate of 1×10⁻³ can be used to learn temporal information.

In some implementations, during the SFT stage, the entire model in FIG. 2A is fine-tuned to enable a comprehensive understanding of visual inputs with encoded temporal information. Smaller learning rates can be applied, for example, 2×10⁻⁶ for the vision encoder and 1×10⁻⁵ for the remaining components of the model.

In some implementations, the training and evaluation paradigms established by the LLaVA series can be used for training and/or evaluation of different models. For example, Siglip-so400 m can be used as the vision encoder, Qwen2 can be used as the LLM decoder, and a two-layer fully connected network (FCN) can be used as the vision-language projector. In some cases, pre-trained parameters from LLaVA-OV-7B and LLaVA-Video7B can be used as backbones to investigate the temporal modeling capabilities of STE. The LMMsEval framework can be used as the backbones to evaluate models and reproduce the backbone results for comparisons. In some cases, GPT-4o can be used for GPT-based evaluations when the default GPT version in LMMs-Eval is unavailable.

In some implementations, (Tᵤ:Tₒ) can be varied across different scenarios to explore the role of explicit temporal modeling. For example, when (Tᵤ:Tₒ) is set to (2:2), the frame count remains fixed, and the influence of temporal encoding can be evaluated without frame compression. For (Tᵤ:Tₒ) configurations of (4:3) and (2:1), the model's performance can be evaluated under layer-wise compression ratios of 25% and 50%, respectively. Stacking these layers multiple times can reduce from 25% to 93.75% frames, and therefore, investigations can be performed on how explicit temporal modeling and compression ratios affect model performance.

In some implementations, for all STE layers, unified hyperparameters can be used for the sliding window size and stride, for example, by setting (T_{w}=2, Tₛ=1). This configuration can be chosen to avoid significant padding when using large sliding windows (e.g., a 16-frame window with a stride of 1 requires padding up to 15 frames), which can be inefficient and may impair tasks such as occurrence counting. By adopting small sliding windows and strides, padding requirements can be minimized while finer temporal information can be captured. Furthermore, multiple convolutional layers can be stacked to gradually expand the temporal receptive field and explore the influence of different temporal learning scales.

In some implementations, experiments can be conducted, for example, on a cluster of 48 NVIDIA® H100 GPUs. For both training and evaluation, 32 frames can be sampled from each video. The model can be trained for one epoch during both the pretraining and SFT phases. The batch size per GPU can be set to 2, except for SFT with STE layers configured as (Tᵤ:Tₒ)=(2:2), where a batch size of 1 can be used to prevent out-of-memory errors.

In some implementations, the video training data of LLaVA Video can be used to train the model, excluding the 1.1 million image-language pairs in order to focus on the video datasets. Example training datasets are described as follows.

ActNet-QA is a dataset designed for activity-based video question answering, containing 23,530 open-ended QA items. NEXT-QA is a dataset supporting temporal and causal relation reasoning in videos, with 17,090 open-ended QA items and 17,024 multiple-choice QA items. PerceptionTest is a dataset targeting fundamental perceptual understanding of videos, comprising 1,803 open-ended QA items. LLaVA-Hound is a diverse video comprehension dataset with 240,000 open-ended QA items and 15,000 caption entries. LLaVA-Video-178K is a comprehensive benchmark featuring videos of 0-3 minutes in duration, including 178,510 caption entries, 960,792 open-ended QA items, and 196,198 multiple-choice QA items.

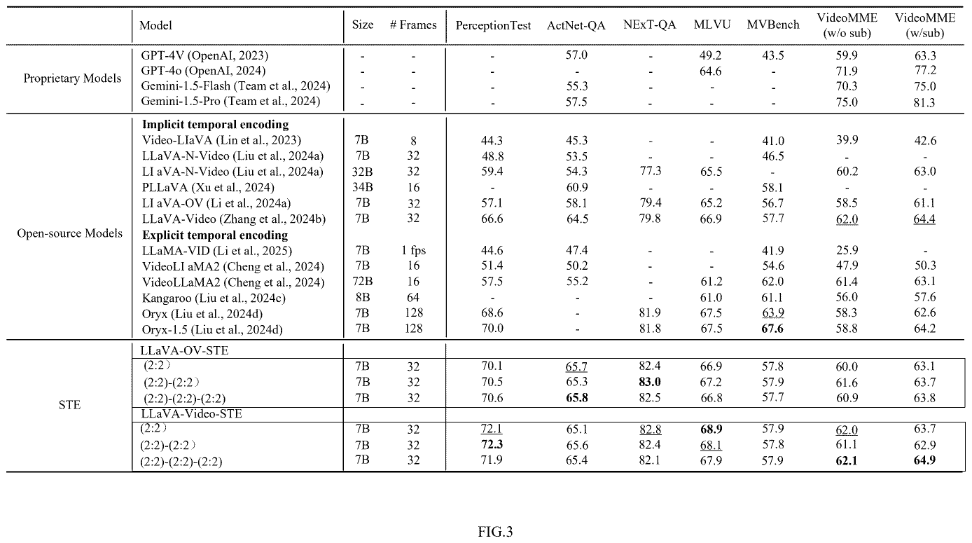

FIG. 3 illustrates example model performance comparisons. The performance of backbones integrated with STE is shaded in grey. The setting (2:2) represents (Tᵤ:Tₒ) for a specific STE layer. The best and second-best scores of open-source models are in bold and underlined.

As shown in FIG. 3, STE is evaluated on six open-ended and multiple-choice video benchmarks. In some cases, ActNetQA and NEXTQA focus on spatio-temporal reasoning of activities and actions. PerceptionTest can be used to test perception ability. MLVU emphasizes long video understanding. VideoMME and MVBench can offer comprehensive evaluations.

Additionally, STE can be assessed on image benchmarks to analyze its impact on image understanding abilities after SFT. The image benchmarks can include single-image dataset, for example, AI2D, DocVQA, InfoVQA, MMMU, MME, MMBench, MMStar, and RealworldQA, and multi-image dataset such as MuirBench.

In some implementations, the necessity of explicit temporal modeling can be demonstrated through its effectiveness in two scenarios: maintaining and compressing frame count. The results of varying STE structures after two-stage training (i.e., pretraining and SFT) are presented in FIG. 3 across six video benchmarks.

As shown in FIG. 3, for the scenario of maintaining frame count, to maintain the frame count, STE layers can be stacked from 1 to 3 to explicitly model temporal information at different time scales. When comparing SOTA open-source video MLLMs, methods utilizing explicit temporal modeling, including STE-based method, generally achieve better performance compared to implicit temporal modeling, particularly among models of similar sizes. This comparison demonstrates the effectiveness of explicit temporal modeling in enhancing video understanding. For example, STE-based method achieves an average performance improvement of up to 4.7% and 1.5% across six benchmarks compared to backbones LLaVAOV and LLaVA-Video, respectively. This comparison demonstrates that explicitly temporal modeling significantly enhances the backbone's ability to understand video content. FIG. 3 also shows that STE-based models consistently outperform the backbones on PerceptionTest, ActNetQA, NEXT-QA, MLVU, and MVBench, indicating that STE strengthens perception and reasoning capabilities. Moreover, STE-based model outperforms VideoLLaMA2 72B, despite having only one-tenth the parameters, and Oryx, despite processing only one-fourth the input video frames. Additionally, all three models, i.e., STE-based, VideoLLaMA2, and Oryx, employ explicit temporal modeling, highlighting that STE is more effective in enhancing temporal learning.

As shown in FIG. 3, for the scenario of compressing frame count, to compress frame counts, STE layers can be stacked with varied frame I/O ratios (Tᵤ:Tₒ) for explicit temporal modeling, or the backbone's sampling frequency can be reduced to lower input frame counts for implicit temporal modeling.

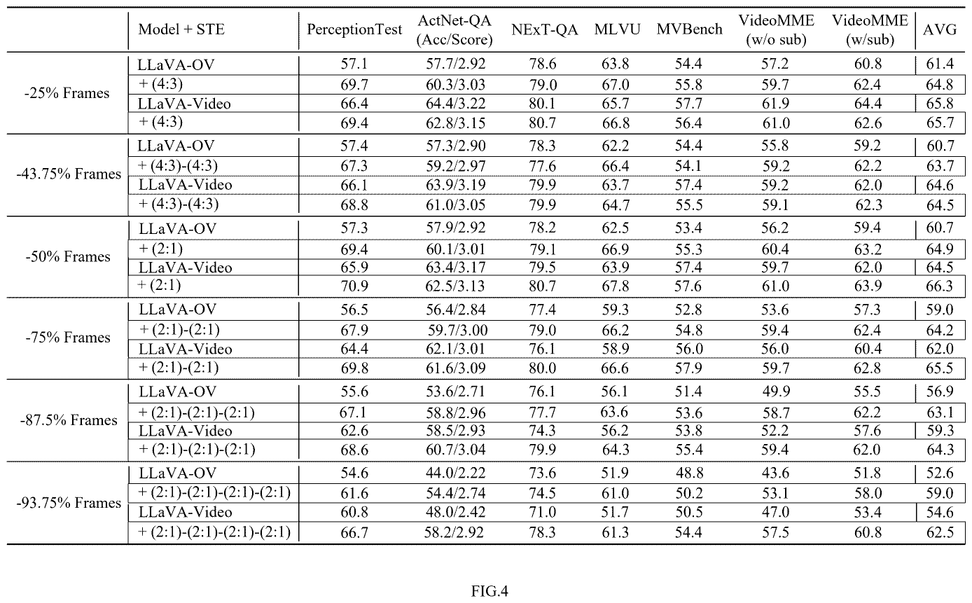

FIG. 4 illustrates example results for different frame compressions (e.g., −25% frames=compression with (Tᵤ:Tₒ) as (4:3), and −50% frames=compression with (Tᵤ:Tₒ) as (2:1)). FIG. 4 shows model performance with (shaded in grey) and without STE when varying frame compression ratios. AVG is the average accuracy.

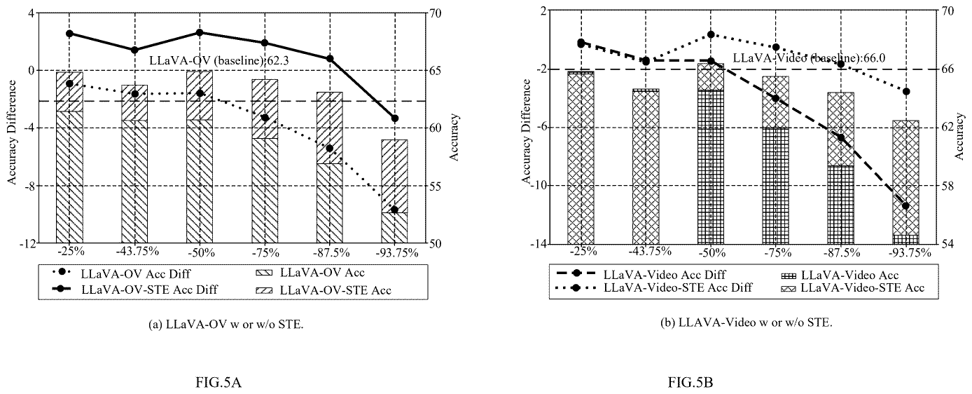

FIGS. 5A and 5B illustrate example results for different frame compressions using bar graphs. In FIGS. 5A and 5B, bars represent accuracy and lines indicate accuracy differences relative to backbones with 32 input frames. FIGS. 5A and 5B show performance when varying frame compression ratios. The results of sampling frequency reduction and frame compression (labeled as STE) show accuracy differences relative to backbones with 32 input frames.

As shown in FIGS. 4, 5A, and 5B, LLaVA-OV-STE consistently outperforms the baseline across frame compressions from 25% to 87.5%. LLaVA-Video-STE remains competitive, underperforming the baseline only at compressions beyond 75%, with a small 0.5% average decrease at 75% compression. However, at 25% and 43.75% frame compressions, LLaVA-Video-STE performs worse than directly sampling fewer frames. These compressions correspond to 1 and 2 STE layers with frame I/O as (4:3), where merging the first frame and part of the second frame into a single abstract frame disrupts embedding completeness and information consistency. For reductions between 50% and 93.75%, STE-based frame compression demonstrates a slower performance decline compared to sampling fewer frames, highlighting its effectiveness in mitigating performance loss from reduced frame counts.

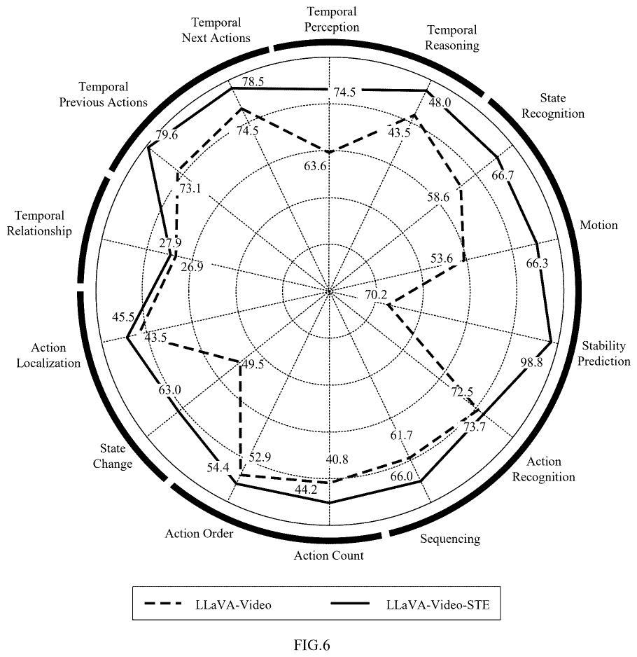

In some implementations, the question of whether explicit temporal modeling improves temporal understanding can be evaluated by investigating task-level performance across six video benchmarks. Tasks related to temporal understanding can be evaluated, comparing LLaVA-OV with and without a 3-layer (2:2) STE in FIG. 1 and LLaVA-Video with and without a 3-layer (2:2) STE in FIG. 6.

FIG. 6 illustrates example results of the performance of LLaVA-Video on temporal-related tasks equipped with (labeled as STE) or without explicit temporal encoding across benchmarks. The results show that STE improves temporal understanding across tasks, benchmarks, and backbones, particularly for stability prediction, motion recognition, temporal perception, and stage change. The results demonstrate that explicitly modeling temporal information can enable the model to better detect temporal changes and comprehend temporal dynamics, thereby enhancing its prediction, recognition, and perception capabilities over sequences of frames.

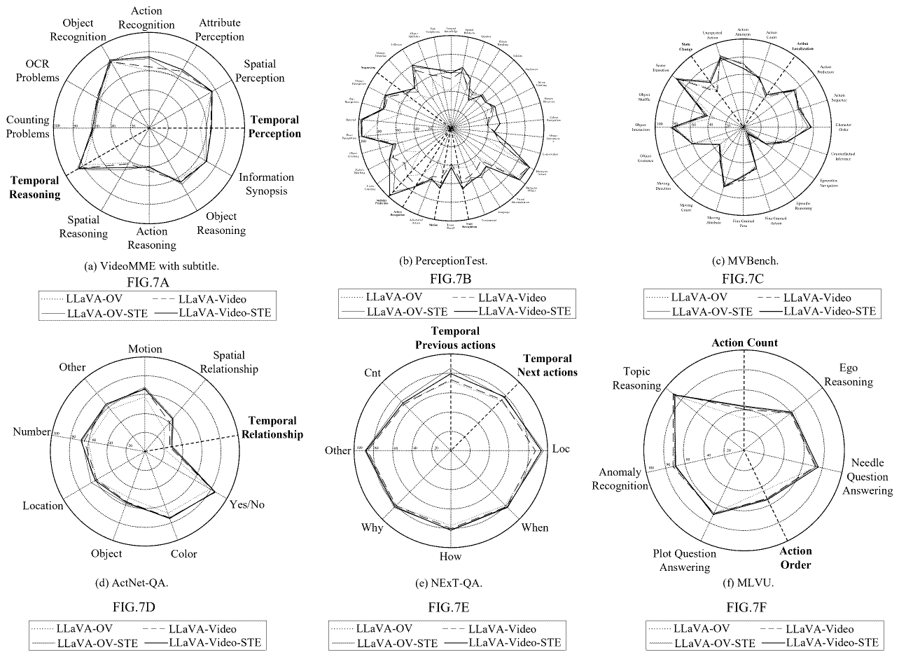

FIGS. 7A-7F illustrate example task-level model performance. LLaVA-OV-STE and LLaVA-Video-STE refer to LLaVA-OV-STE-3-(2:2) and LLaVA-Video-STE-3-(2:2), respectively.

As shown in FIG. 7A, for VideoMME, STE can consistently enhance models' abilities in temporal reasoning, temporal perception, spatial reasoning, and action recognition, while other abilities remain at similar performance levels.

As shown in FIG. 7B, for PerceptionTest, STE can significantly improve models' performance in stability prediction, recognition of actions, object attributes, task completion, state, and motion, with other abilities showing comparable performance.

As shown in FIG. 7C, for MVBench, STE can consistently boost models' capabilities in state change and action localization, while other abilities are unaffected.

As shown in FIG. 7D, for ActNet-QA, STE can consistently enhance models' capabilities in temporal relationship and spatial relationship, while other abilities are unaffected.

As shown in FIG. 7E, for NEXT-QA, STE can improve models' understanding of temporal sequences, for example, in predicting previous and next actions, with no significant changes in other abilities.

As shown in FIG. 7F, for MLVU, STE can enhance models' proficiency in action count and order, with a slight improvement in ego reasoning. Other abilities remain consistent.

As shown in FIGS. 7A-7F, across diverse video benchmarks, STE can consistently strengthen models' temporal and spatial reasoning capabilities, for example, excelling in action recognition, state change, temporal sequence prediction, and stability analysis. While other abilities remain largely unaffected, the results underscore the value of explicit temporal modeling in enhancing models' understanding of complex temporal and spatial relationships in video data.

In some implementations, the question of how STE improves temporal understanding and compensates for information loss when compressing frames can be investigated.

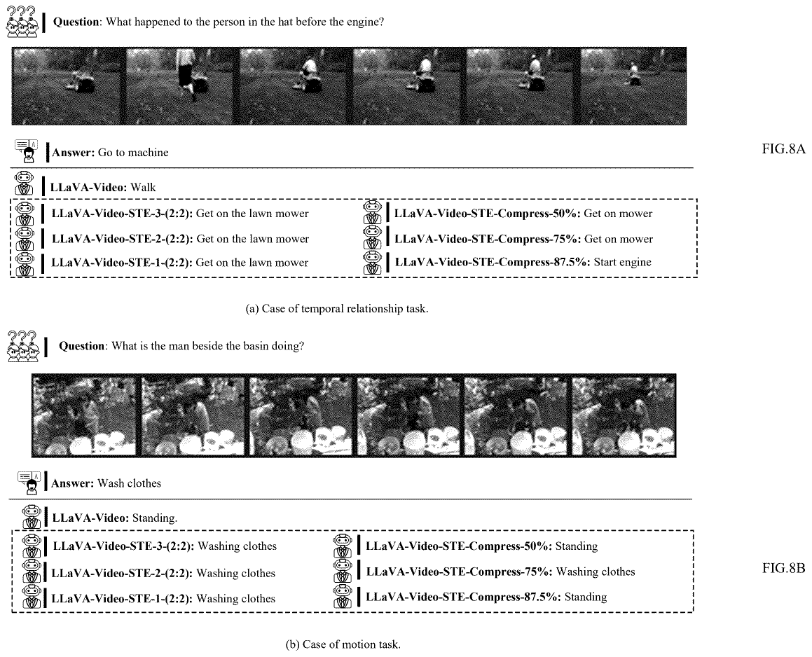

FIGS. 8A and 8B illustrate an example case study of ActNet-QA. LLaVA-Video-STE-1/2/3-(2:2) represents LLaVA-Video-STE using 1/2/3 layers of (2:2).

As shown in FIGS. 8A and 8B, cases of LLaVA-Video with and without STE-based module are compared on a temporal relationship task and a motion recognition task from ActNet-QA. In some cases, LLaVA-Video may rely on single-frame understanding, neglecting temporal context, e.g., identifying “walk” or “standing” without considering temporal information. In contrast, the STE-based module can incorporate a broader temporal context, enabling more accurate predictions. For example, in FIG. 8A, the STE-based module can integrate the surrounding frames to deduce that the man is to “get on the lawn mower.” However, reducing tokens can lead to missed information, e.g., predicting “mower” instead of “lawn mower.” In some cases, when 87.5% of tokens are compressed, the STE model focuses on high-level semantics, predicting that the reason for the man going to the machine is to start the engine. FIG. 8B illustrates another important result: longer temporal encoding may compensate for missed information caused by token reduction, enabling correct recognition of “washing” with a 75% token reduction. The result shows that an extended temporal receptive field can mitigate information loss under high-ratio token compression.

In some implementations, the question of how to design explicit temporal modeling can be investigated. For example, two factors in the design of STE, i.e., the temporal receptive field and the temporal learning space, can be analyzed. The analyses can provide insights into how convolutional-based temporal encoders can be designed when explicit temporal modeling is needed.

In some implementations, to evaluate how expanding the temporal receptive field affects model performance, 1, 2, and 3 STE layers of (2:2) can be stacked. The stacking gradually increases the temporal receptive field covered by the sliding window in the final layer, while fixing all other parameters and retaining the full number of frames without compression.

As shown in FIG. 3, expanding the temporal receptive field may not lead to significant changes in overall performance, with average accuracy remaining relatively stable across configurations. The robustness can be attributed to the design of each STE layer, for example, by using a window size of 2 and a stride of 1, even a single layer can capture fine-grained and continuous temporal relationships across adjacent frames. While stacking more layers increases the temporal receptive field and captures longer-range dependencies, the additional information may not significantly benefit the evaluated tasks.

However, the 3-layer STE consistently achieves strong performance, securing the best or second-best average performance. The 3-layer STE also delivers the best performance in several individual benchmarks, such as VideoMME and MLVU. The results suggest that while increasing the temporal receptive field alone may not guarantee substantial performance gains, carefully selecting the number of layers can yield consistently strong results for designing temporal modules.

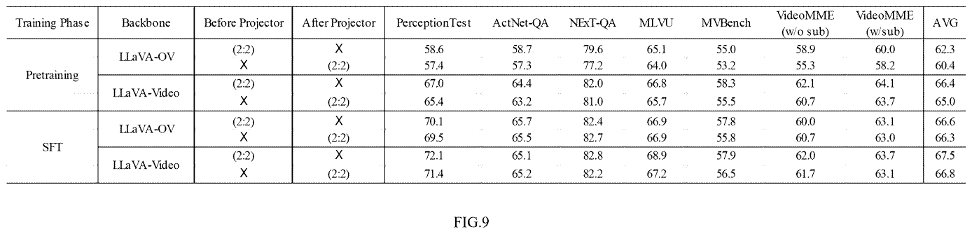

In some implementations, the question of how the location of temporal learning, either in the visual or semantic space, affects model performance can be investigated. Temporal encoders can be inserted after the vision encoder and before the vision-language projector (learning in the visual space) or after the projector and before the LLM (learning in the semantic space). FIG. 9 illustrates example results comparing temporal learning in the visual space and the semantic space during both the pretraining and SFT stages. As shown in FIG. 9, across both backbones and training stages, learning temporal information in the visual space consistently outperforms the semantic space. The results suggest that temporal correlations in visual features are continuous and well-suited for learning through sliding windows, whereas temporal information in the semantic space may be discontinuous, owing to tokenized patches. While SFT narrows the performance gap, likely due to the LLM's improved capacity for processing semantic temporal relationships, the gap persists, for example, for LLaVA-Video (0.7% lower average performance).

Additionally, as shown in FIG. 9, the embedding size in the semantic space is expanded, requiring a larger STE with substantially more parameters (approximately 9.7× larger, ~2.65 million vs. ~25.69 million). This further underscores the inefficiency of learning temporal information in the semantic space. The results highlight the importance of applying convolutional temporal modeling in the visual space, where temporal relationships are more continuous and computationally efficient.

In some implementations, different combinations of learning spaces and compression ratios can be evaluated.

In some implementations, stacking strategies for STE under varying compression ratios and temporal learning spaces can be evaluated.

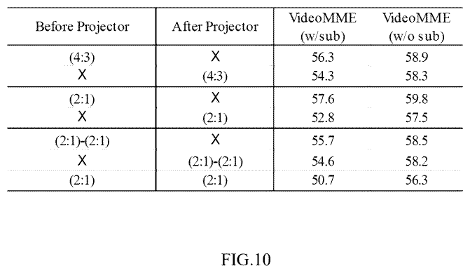

FIG. 10 illustrates example learning space ablation as a plug-in module. When using STE as a 1-layer plug-in, applying convolution in the semantic space results in a greater performance drop as the compression ratio increases. For example, on VideoMME without subtitles, the performance drops by 2% and 4.8% for semantic-space convolution compared to visual-space convolution under different compression ratios. When comparing three stacking strategies (visual space only, semantic space only, and both spaces), applying convolution exclusively in the visual space consistently achieves the best performance. Both visual-only and semantic-only configurations significantly outperform the combined approach (convolution in both spaces). The combined approach introduces higher computational overhead and requires more training, making it less efficient. These results emphasize the importance of domain-specific modeling, with the visual space offering the best performance and efficiency.

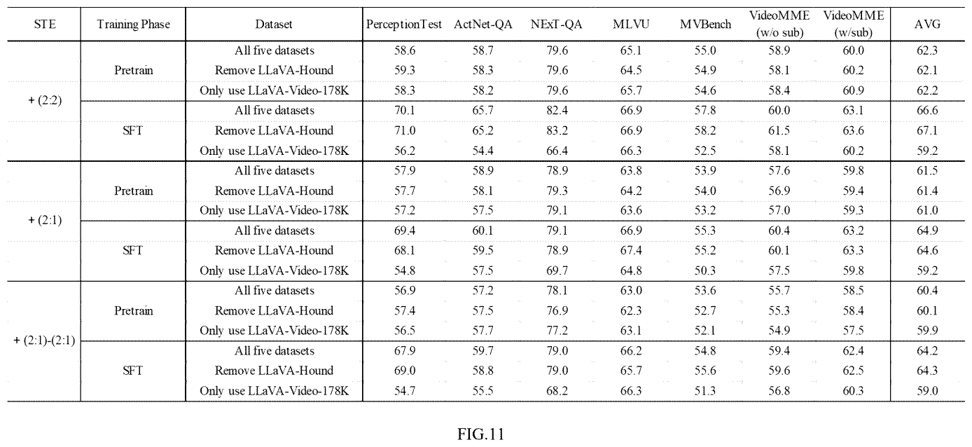

FIG. 11 illustrates example dataset ablation of LLaVA-OV. As shown in FIG. 11, the impact of dataset selection can be evaluated by considering 1-layer STE of (2:2) and ½-layer STE of (2:1) to assess the influence of datasets on maintaining or compressing frame counts. The evaluation in FIG. 11 is based on LLaVA-OV. FIG. 11 shows several important insights. First, during the pretraining stage, using all five datasets consistently yields the best performance. The use of only LLaVA-Video-178K or LLaVA-Video-178K combined with three additional in-domain datasets does not significantly impact the final results. Second, during the SFT stage, the model is fine-tuned with the same datasets used in pretraining. The results indicate that whether LLaVA-hound is included or not, the average score remains similar. However, using only LLaVA-Video-178K leads to a significant decrease in performance across all benchmarks. Based on the results, all five datasets can be used for stable pretraining and SFT performance in video training.

In some implementations, the broader implications of explicit temporal modeling can be explored, particularly when using STE as a plug-in module and in image modalities.

In some implementations, STE's utility as a plug-in module can be evaluated for video understanding tasks, focusing on its ability to compress temporal frames while maintaining performance.

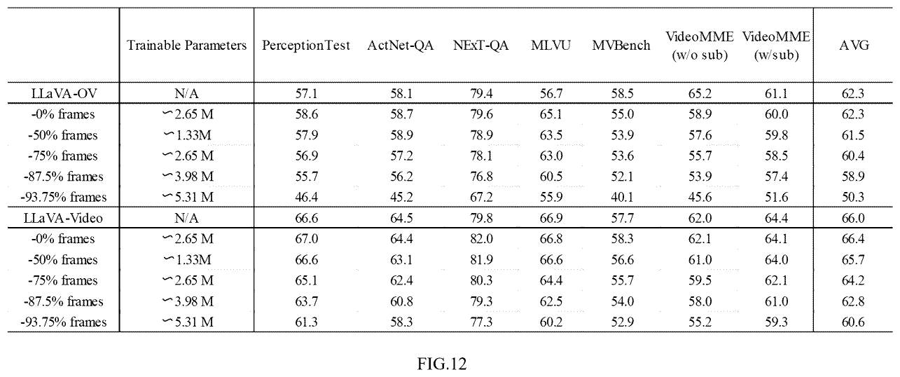

FIG. 12 illustrates example results of using STE pre-trained on video data and evaluated under varying frame reductions. One to four STE layers are stacked with a (2:1) I/O frame ratio, progressively reducing frames by 50%, 75%, 87.5%, and 93.75%.

As shown in FIG. 12, despite being lightweight (with fewer than 5.31 million trainable parameters compared to the 7 billion trainable parameters in backbone), STE demonstrates robust performance. With the full set of frames, STE improves LLaVA-Video's accuracy by 0.4% and maintains LLaVA-OV's performance. Even under significant frame reductions, STE effectively mitigates performance degradation. For instance, with a 75% frame compression, LLaVAOV experiences only a 1.9% drop in average accuracy and LLaVA-Video drops by just 2.2%. Remarkably, even with a 93.75% frame compression, the models achieve 50.3% (LLaVA-OV-STE) and 60.6% (LLaVA-Video-STE) average accuracy, demonstrating STE's robustness under extreme compression. The results highlight STE's ability to compensate for information loss caused by frame reductions by capturing longer-range temporal dependencies, thereby slowing performance decline. The results underscore STE's broader applicability as a plug-in module for fast adaptation without SFT to video datasets and for computationally constrained scenarios requiring frame reduction.

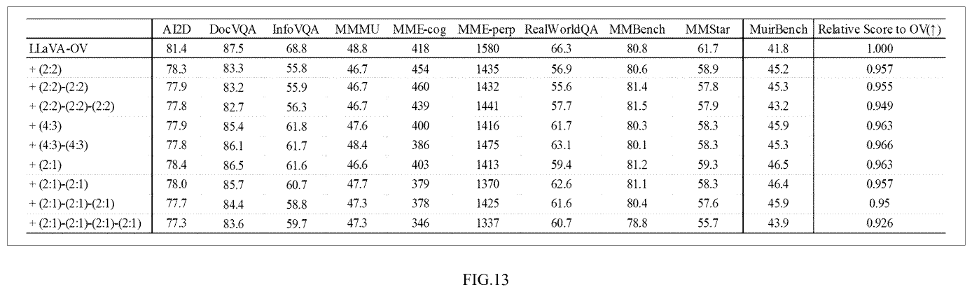

FIG. 13 illustrates single-image and multi-image ability after SFT. As shown in FIG. 13, the mean relative score to the original LLaVA-OV can be calculated using the formula

$$\frac{1}{N} {\sum }_{i = 1}^{N} \frac{{score}_{STE , i}}{{score}_{OV , i}} ,$$

in order to evaluate the model's image ability after SFT. Since pretraining only updates STE module, which does not apply to images, the model's image ability changes only after SFT. Therefore, the changes in image ability after fine-tuning the entire model with video data can be investigated. In some cases, the STE model on 9 single-image benchmarks and 1 multi-image benchmark (i.e., MuirBench) can be evaluated. As shown in FIG. 13, while the model's performance improves on the multi-image benchmark, it decreases on most single-image benchmarks. In most cases, the STE model maintains around 95% of the original image ability, indicating that training the model exclusively on video data results in a slight decrease in image ability and emphasizes the need for image data during video training.

In some implementations, stacking additional layers with (2:2) and (2:1) can result in a continuous decline in image ability, with the decrease becoming more pronounced. The decline suggests that visual embeddings encoded with longer temporal information exacerbate the gap between video and image representations.

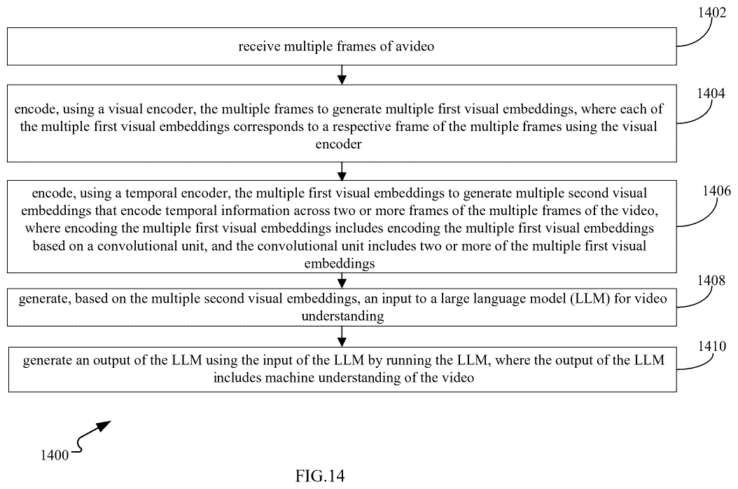

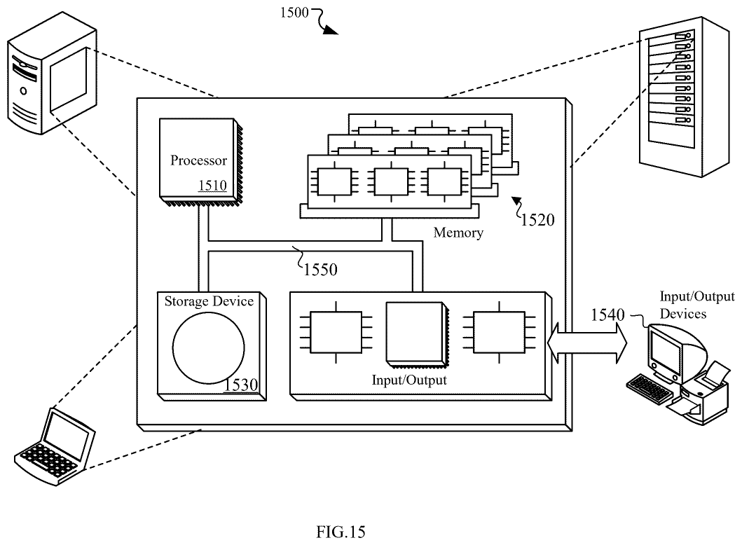

FIG. 14 illustrates an example process 1400 of video understanding using a large language model. Process 1400 can be performed by any suitable device or system as described herein, for example, according to the example techniques described with respect to FIGS. 1-13. For convenience, process 1400 will be described as being performed by a computer system. An example computer system is computer system 1500 shown in FIG. 15. The operations shown in process 1400 may not be exhaustive and that other operations can be performed as well before, after, or in between any of the illustrated operations. Further, some of the operations may be performed simultaneously, or in a different order than shown in FIG. 14. In some implementations, some of the operations may be performed by or one or more components of a device or a system.

At 1402, a computer system receives a plurality frames of a video. The plurality frames of a video can be, for example, video data Xᵥ described with respect to FIG. 2A.

At 1404, the computer system encodes, using a visual encoder (e.g., the vision encoder 202), the plurality frames to generate a plurality of first visual embeddings (e.g., visual embeddings 242, 244, 246, and/or 248), wherein each of the plurality of first visual embeddings corresponds to a respective frame of the plurality frames.

At 1406, the computer system encodes, using a temporal encoder (e.g., the STE 204), the plurality of first visual embeddings to generate a plurality of second visual embeddings (e.g., combined visual embeddings 252,254, 256 and/or 258) that encode temporal information across two or more frames of the plurality frames of the video, wherein encoding the plurality of first visual embeddings comprises encoding the plurality of first visual embeddings based on a convolutional unit (e.g., convolutional unit 212), and wherein the convolutional unit comprises two or more of the plurality of first visual embeddings.

At 1408, the computer system generates, based on the plurality of second visual embeddings, an input to a large language model (LLM) (e.g., LLM decoder 208) for video understanding.

At 1410, the computer system generates an output of the LLM using the input of the LLM by running the LLM, wherein the output of the LLM comprises machine understanding of the video.

In some implementations, encoding the plurality of first visual embeddings includes catenating the plurality of first visual embeddings along a temporal dimension.

In some implementations, encoding the plurality of first visual embeddings includes dividing the plurality of first visual embeddings into a plurality of convolutional units (e.g., convolutional units 212), and applying a stackable temporal encoding operation (e.g., an STE operation 220 or 230) on each of the plurality of convolutional units.

In some implementations, the stackable temporal encoding operation includes convolving, using a convolutional kernel with a convolutional window size, the plurality of first visual embeddings within the convolutional unit, and sliding the convolutional kernel within the convolutional unit with a stride along a temporal dimension.

In some implementations, the temporal encoder comprises multiple layers, the encoding the plurality of first visual embeddings based on the convolutional unit comprises encoding the plurality of first visual embeddings based on a first layer of the temporal encoder (e.g., a layer associated with the STE operation 220), and the process 1400 further includes encoding the plurality of second visual embeddings based on a second layer of the temporal encoder (e.g., a layer associated with the STE operation 230) to generate a plurality of third visual embeddings, and the generating, based on the plurality of second visual embeddings, the input to the LLM comprises generating, based on the plurality of third visual embeddings, the input to the LLM.

In some implementations, the encoding the plurality of second visual embeddings based on the second layer of the temporal encoder to generate the plurality of third visual embeddings comprises reshaping the plurality of second visual embeddings into a plurality of second convolutional units, and applying a second stackable temporal encoding operation (e.g., the STE operation 230) on each of the plurality of second convolutional units.

In some implementations, a size of each of the plurality of the second visual embeddings is the same as a size of each of the plurality of the third visual embeddings.

In some implementations, a total frame count corresponding to the plurality of first visual embeddings along a temporal dimension is not a multiple of a total frame count corresponding to the convolutional unit, and encoding the plurality of first visual embeddings comprises padding the plurality of first visual embeddings with additional visual embeddings along the temporal dimension to generate a plurality of padded first visual embeddings, wherein a total frame count corresponding to the plurality of padded first visual embeddings is a multiple of the total frame count corresponding to the convolutional unit.

In some implementations, each of the plurality of second visual embeddings has the same size as each of the plurality of first visual embeddings.

In some implementations, generating, based on the plurality of second visual embeddings, the input to the LLM comprises generating, using a vision-language projector (e.g., the vision-language projector 206) and as the input to the LLM, an output of the vision-language projector using the plurality of second visual embeddings as an input to the vision-language projector.

In some implementations, the LLM is a Multimodal Large Language Model (MLLM) trained for image-text understanding, the input of the LLM further comprises one or more language instructions provided by a user, and generating the output of the LLM using the input of the LLM by running the LLM comprises generating a language response to the one or more language instructions provided by the user that comprises the machine understanding of the video based on the one or more language instructions provided by the user.

In some implementations, before encoding, using the visual encoder, the plurality frames to generate the plurality of first visual embeddings, the method further comprises training the temporal encoder while keeping parameters of the visual encoder and the LLM fixed.

In some implementations, after training the temporal encoder, the method further comprises training the visual encoder, the temporal encoder, and the LLM together.

In some implementations, encoding the plurality of first visual embeddings comprises convolving a convolutional kernel with the plurality of first visual embeddings, wherein a size of the convolutional kernel is larger than or equal to a sum of (1) a size of a first visual embedding of the plurality of first visual embeddings and (2) a size of a second visual embedding of the plurality of first visual embeddings.

FIG. 15 illustrates a schematic diagram of an example computer system 1500. The system 1500 can be used for the operations described in association with the implementations described herein. For example, the system 1500 may be included in any or all of the server components discussed herein. The system 1500 includes a processor 1510, a memory 1520, a storage device 1530, and an input/output device 1540. The components 1510, 1520, 1530, and 1540 are interconnected using a system bus 1550. The processor 1510 is capable of processing instructions for execution within the system 1500. In some implementations, the processor 1510 is a single-threaded processor. The processor 1510 is a multi-threaded processor. The processor 1510 is capable of processing instructions stored in the memory 1520 or on the storage device 1530 to display graphical information for a user interface on the input/output device 1540.

The memory 1520 stores information within the system 1500. In some implementations, the memory 1520 is a computer-readable medium. The memory 1520 can be a volatile memory unit or a non-volatile memory unit. The storage device 1530 is capable of providing mass storage for the system 1500. The storage device 1530 is a computer-readable medium. The storage device 1530 may be a floppy disk device, a hard disk device, an optical disk device, or a tape device. The input/output device 1540 provides input/output operations for the system 1500. The input/output device 1540 includes a keyboard and/or pointing device. The input/output device 1540 includes a display unit for displaying graphical user interfaces.

The subject matter and the actions and operations described in this specification can be implemented in digital electronic circuitry, in tangibly embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively, or in addition to, the carrier can be an artificially generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices.

To provide for interaction with a user, the subject matter described in this specification can be implemented on one or more computers having, or configured to communicate with, a display device, e.g., an LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a plurality frames of a video;
encoding, using a visual encoder, the plurality frames to generate a plurality of first visual embeddings, wherein each of the plurality of first visual embeddings corresponds to a respective frame of the plurality frames;
encoding, using a temporal encoder, the plurality of first visual embeddings to generate a plurality of second visual embeddings that encode temporal information across two or more frames of the plurality frames of the video, wherein encoding the plurality of first visual embeddings comprises encoding the plurality of first visual embeddings based on a convolutional unit, and wherein the convolutional unit comprises two or more of the plurality of first visual embeddings;
generating, based on the plurality of second visual embeddings, an input to a large language model (LLM) for video understanding; and
generating an output of the LLM using the input of the LLM by running the LLM, wherein the output of the LLM comprises machine understanding of the video.

2. The computer-implemented method of claim 1, wherein encoding the plurality of first visual embeddings comprises:
catenating the plurality of first visual embeddings along a temporal dimension.

3. The computer-implemented method of claim 1, wherein encoding the plurality of first visual embeddings comprises:
dividing the plurality of first visual embeddings into a plurality of convolutional units; and
applying a stackable temporal encoding operation on each of the plurality of convolutional units.

4. The computer-implemented method of claim 3, wherein the stackable temporal encoding operation comprises:
convolving, using a convolutional kernel with a convolutional window size, the plurality of first visual embeddings within the convolutional unit; and
sliding the convolutional kernel within the convolutional unit with a stride along a temporal dimension.

5. The computer-implemented method of claim 3, wherein:
the temporal encoder comprises multiple layers,
the encoding the plurality of first visual embeddings based on the convolutional unit comprises encoding the plurality of first visual embeddings based on a first layer of the temporal encoder, and
the method further comprises encoding the plurality of second visual embeddings based on a second layer of the temporal encoder to generate a plurality of third visual embeddings, and
the generating, based on the plurality of second visual embeddings, the input to the LLM comprises generating, based on the plurality of third visual embeddings, the input to the LLM.

6. The computer-implemented method of claim 5, wherein the encoding the plurality of second visual embeddings based on the second layer of the temporal encoder to generate the plurality of third visual embeddings comprises:
reshaping the plurality of second visual embeddings into a plurality of second convolutional units; and
applying a second stackable temporal encoding operation on each of the plurality of second convolutional units.

7. The computer-implemented method of claim 5, wherein a size of each of the plurality of the second visual embeddings is the same as a size of each of the plurality of the third visual embeddings.

8. The computer-implemented method of claim 1, wherein a total frame count corresponding to the plurality of first visual embeddings along a temporal dimension is not a multiple of a total frame count corresponding to the convolutional unit, and encoding the plurality of first visual embeddings comprises:
padding the plurality of first visual embeddings with additional visual embeddings along the temporal dimension to generate a plurality of padded first visual embeddings, wherein a total frame count corresponding to the plurality of padded first visual embeddings is a multiple of the total frame count corresponding to the convolutional unit.

9. The computer-implemented method of claim 1, wherein each of the plurality of second visual embeddings has the same size as each of the plurality of first visual embeddings.

10. The computer-implemented method of claim 1, wherein generating, based on the plurality of second visual embeddings, the input to the LLM comprises:
generating, using a vision-language projector and as the input to the LLM, an output of the vision-language projector using the plurality of second visual embeddings as an input to the vision-language projector.

11. The computer-implemented method of claim 1, wherein the LLM is a Multimodal Large Language Model (MLLM) trained for image-text understanding; the input of the LLM further comprises one or more language instructions provided by a user; and
wherein generating the output of the LLM using the input of the LLM by running the LLM comprises generating a language response to the one or more language instructions provided by the user that comprises the machine understanding of the video based on the one or more language instructions provided by the user.

12. The computer-implemented method of claim 1, wherein before encoding, using the visual encoder, the plurality frames to generate the plurality of first visual embeddings, the method further comprises:
training the temporal encoder while keeping parameters of the visual encoder and the LLM fixed.

13. The computer-implemented method of claim 12, wherein after training the temporal encoder, the method further comprises:
training the visual encoder, the temporal encoder, and the LLM together.

14. The computer-implemented method of claim 1, wherein encoding the plurality of first visual embeddings comprises:
convolving a convolutional kernel with the plurality of first visual embeddings, wherein a size of the convolutional kernel is larger than or equal to a sum of (1) a size of a first visual embedding of the plurality of first visual embeddings and (2) a size of a second visual embedding of the plurality of first visual embeddings.

15. A non-transitory computer-readable medium storing one or more instructions executable by a computer system to perform operations comprising:
receiving a plurality frames of a video;
encoding, using a visual encoder, the plurality frames to generate a plurality of first visual embeddings, wherein each of the plurality of first visual embeddings corresponds to a respective frame of the plurality frames;
encoding, using a temporal encoder, the plurality of first visual embeddings to generate a plurality of second visual embeddings that encode temporal information across two or more frames of the plurality frames of the video, wherein encoding the plurality of first visual embeddings comprises encoding the plurality of first visual embeddings based on a convolutional unit, and wherein the convolutional unit comprises two or more of the plurality of first visual embeddings;
generating, based on the plurality of second visual embeddings, an input to a large language model (LLM) for video understanding; and
generating an output of the LLM using the input of the LLM by running the LLM, wherein the output of the LLM comprises machine understanding of the video.

16. The non-transitory computer-readable medium of claim 15, wherein encoding the plurality of first visual embeddings comprises:
catenating the plurality of first visual embeddings along a temporal dimension.

17. The non-transitory computer-readable medium of claim 15, wherein encoding the plurality of first visual embeddings comprises:
dividing the plurality of first visual embeddings into a plurality of convolutional units; and
applying a stackable temporal encoding operation on each of the plurality of convolutional units.

18. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
receiving a plurality frames of a video;
encoding, using a visual encoder, the plurality frames to generate a plurality of first visual embeddings, wherein each of the plurality of first visual embeddings corresponds to a respective frame of the plurality frames;
encoding, using a temporal encoder, the plurality of first visual embeddings to generate a plurality of second visual embeddings that encode temporal information across two or more frames of the plurality frames of the video, wherein encoding the plurality of first visual embeddings comprises encoding the plurality of first visual embeddings based on a convolutional unit, and wherein the convolutional unit comprises two or more of the plurality of first visual embeddings;
generating, based on the plurality of second visual embeddings, an input to a large language model (LLM) for video understanding; and
generating an output of the LLM using the input of the LLM by running the LLM, wherein the output of the LLM comprises machine understanding of the video.

19. The computer-implemented system of claim 18, wherein encoding the plurality of first visual embeddings comprises:
catenating the plurality of first visual embeddings along a temporal dimension.

20. The computer-implemented system of claim 18, wherein encoding the plurality of first visual embeddings comprises:
dividing the plurality of first visual embeddings into a plurality of convolutional units; and
applying a stackable temporal encoding operation on each of the plurality of convolutional units.
